(19) United States
(12) Patent Application Publication
(10) Pub. No.: US 2026/0353500 A1
(43) Pub. Date: Nov. 5, 2026

(54) METHODS AND APPARATUSES FOR USER EQUIPMENT POSITIONING

(71) Applicant: LENOVO (BEIJING) LIMITED, Beijing (CN)

(72) Inventors: Jie Hu, Beijing (CN); Haiming Wang, Beijing (CN); Jing Han, Beijing (CN); Lihua Yang, Beijing (CN)

(21) Appl. No.: 19/101,943

(22) PCT Filed: Aug. 8, 2022
(86) PCT No.: PCT/CN2022/110830

§ 371 Date: Feb. 7, 2025

(51) Int. Cl. H04W 76/27; H04L 5/00

(52) U.S. Cl. CPC H04W 76/27; H04L 5/0051

(57) ABSTRACT

Embodiments of the present application are related to methods and apparatuses for user equipment (UE) positioning. An embodiment of the present application provides a UE including: a transceiver configured to: receive a sounding reference signal (SRS) configuration for a radio resource control (RRC) idle state via an RRC connection release message; and a processor coupled to the transceiver and configured to: transition from an RRC connected state to the RRC idle state; and perform uplink (UL) positioning in the RRC idle state in accordance with the SRS configuration.

### TECHNICAL FIELD

The present disclosure generally relates to wireless communications, and especially to user equipment (UE) positioning.

### BACKGROUND OF THE INVENTION

Uplink (UL) positioning (e.g., UL sounding reference signal (SRS) measurements) is supported in current wireless technology. For UEs in a radio resource control (RRC) connected state or an RRC inactive state, various aspects in UL positioning procedures (e.g., SRS configuration, time alignment (TA), etc.) have been developed or proposed. However, details of UL positioning procedures for UEs in an RRC idle state have not been discussed yet.

### SUMMARY

Some embodiments of the present disclosure provide a UE including: a transceiver configured to: receive an SRS configuration for an RRC idle state via an RRC connection release message; and a processor coupled to the transceiver and configured to: transition from an RRC connected state to the RRC idle state; and perform UL positioning in the RRC idle state in accordance with the SRS configuration.

In some embodiments, the transceiver is further configured to transmit a request for the SRS configuration for the RRC idle state when the UE is in the RRC connected state.

In some embodiments, the request includes at least one of: positioning capability information indicating that the UE supports UL positioning in the RRC idle state; or a low power requirement of a positioning service.

In some embodiments, the RRC connection release message further includes a positioning area associated with the SRS configuration.

In some embodiments, the positioning area includes at least one of: one or more cells within a core network (CN) tracking area or radio access network (RAN) based notification area (RNA); one or more cells managed by a same location management function (LMF) as a serving cell where the SRS configuration is received; one or more neighboring cells surrounding the serving cell; or one or more cells within a range of the serving cell.

In some embodiments, the SRS configuration is valid only when the UE is within a serving cell where the SRS configuration is received or within the positioning area.

In some embodiments, the SRS configuration is valid only when the UE is within a serving cell where the SRS configuration is received in the case that a positioning area associated with the SRS configuration is not configured.

In some embodiments, the RRC connection release message further includes a valid time associated with the SRS configuration.

In some embodiments, the processor is further configured to release the SRS configuration when the valid time expires.

In some embodiments, the SRS configuration includes a first TA configuration, wherein the first TA configuration includes a TA timer and a reference signal received power (RSRP) change threshold, and wherein the processor is further configured to start the TA timer and store an RSRP value of a serving cell where the first TA configuration is received as a current serving cell RSRP value upon reception of the first TA configuration.

In some embodiments, the RRC connection release message further includes a radio network temporary identity (RNTI) for identifying downlink control information (DCI) signaling for the UE in the RRC idle state.

In some embodiments, the transceiver is further configured to receive DCI signaling with cyclic redundancy check (CRC) scrambled by the RNTI when the UE is in the RRC idle state, wherein the DCI signaling includes a TA command or a TA update; and the processor is further configured to restart the TA timer upon reception of the DCI signaling.

In some embodiments, the DCI signaling is received following a configured SRS transmission period or interval according to the SRS configuration.

In some embodiments, in the case that a positioning area associated with the SRS configuration is configured and the UE moves from a first cell within the positioning area to a second cell within the positioning area, the processor is further configured to acquire a second TA configuration associated with the second cell.

In some embodiments, to acquire the second TA configuration, the transceiver is further configured to: transmit an MSG1 or MSGA by using a preamble and physical random access channel (PRACH) resource configured in a system information block (SIB); and receive an MSG2 or MSGB including the second TA configuration, without transmitting an MSG3; and the processor is further configured to apply the second TA configuration and start a TA timer according to the second TA configuration after acquiring the second TA configuration.

In some embodiments, the preamble is a dedicated preamble for SRS TA purpose or a shared preamble.

In some embodiments, in the case that a positioning area associated with the SRS configuration is configured, the processor is further configured to release the SRS configuration and determine that a current TA is invalid when the UE moves out of the positioning area.

In some embodiments, the processor is configured to perform the following operations before each SRS transmission when the UE is in the RRC idle state: determining whether the SRS configuration is valid; and determining whether a current TA is valid; and the SRS transmission is performed in the case that both the SRS configuration and the current TA are determined to be valid.

In some embodiments, the processor is further configured to: release the SRS configuration when the SRS configuration becomes invalid.

In some embodiments, the processor is further configured to: suspend the SRS configuration in the case that the current TA is determined to be invalid; and resume the SRS configuration when the current TA becomes valid or a new TA configuration is acquired successfully.

In some embodiments, the processor is configured to determine that the SRS configuration is invalid when the current TA is invalid.

In some embodiments, the processor is configured to determine that the current TA is invalid in at least one of the following cases: a current TA timer associated with the current TA expires; the UE moves to a cell different from that associated with the current TA; or an RSRP change exceeds a current RSRP change threshold associated with the current TA.

In some embodiments, the processor is further configured to release the SRS configuration when the SRS configuration has not been used for a configured number of consecutive occasions for SRS transmission in the RRC idle state.

In some embodiments, the processor is further configured to release the SRS configuration when a cell reselection is performed or an RRC resume procedure is initiated to a cell different from a serving cell where the RRC connection release message is received.

Some embodiments of the present disclosure provide a base station (BS) including: a processor configured to: determine to transition a UE from an RRC connected state to an RRC idle state; and a transceiver coupled to the processor and configured to: transmit an SRS configuration for the RRC idle state via an RRC connection release message; and perform SRS reception for UL positioning in accordance with the SRS configuration after the UE is transitioned to the RRC idle state.

In some embodiments, the transceiver is further configured to receive a request for the SRS configuration from the UE when the UE is in the RRC connected state.

In some embodiments, the request includes at least one of: positioning capability information indicating that the UE supports UL positioning in the RRC idle state; or a low power requirement of a positioning service.

In some embodiments, the SRS configuration is transmitted when there is no other ongoing data transmission except for positioning service.

In some embodiments, the RRC connection release message further includes a positioning area associated with the SRS configuration.

In some embodiments, the processor is configured to perform SRS reception and measurement associated with the UE in cell(s) within the positioning area.

In some embodiments, the positioning area includes at least one of: one or more cells within a CN tracking area or RNA; one or more cells managed by a same LMF as a serving cell where the SRS configuration is transmitted; one or more neighboring cells surrounding the serving cell; or one or more cells within a range of the serving cell.

In some embodiments, the SRS configuration is valid only when the UE is within a serving cell where the SRS configuration is transmitted or within the positioning area.

In some embodiments, the SRS configuration is valid only when the UE is within a serving cell where the SRS configuration is transmitted in the case that a positioning area associated with the SRS configuration is not configured.

In some embodiments, the RRC connection release message further includes a valid time associated with the SRS configuration.

In some embodiments, the processor is further configured to release the SRS configuration when the valid time expires.

In some embodiments, the SRS configuration includes a first TA configuration, wherein the first TA configuration includes a TA timer and an RSRP change threshold.

In some embodiments, the RRC connection release message further includes an RNTI for identifying DCI signaling for the UE in the RRC idle state.

In some embodiments, the transceiver is further configured to transmit DCI signaling with CRC scrambled by the RNTI when the UE is in the RRC idle state, wherein the DCI signaling includes a TA command or a TA update.

In some embodiments, the DCI signaling is transmitted following a configured SRS transmission period or interval according to the SRS configuration.

In some embodiments, in the case that a positioning area associated with the SRS configuration is configured, the transceiver is further configured to: receive an MSG1 or MSGA with a preamble and PRACH resource configured in a SIB from the UE in the RRC idle state; and transmit an MSG2 or MSGB including a second TA configuration.

In some embodiments, the preamble is a dedicated preamble for SRS TA purpose or a shared preamble.

In some embodiments, the processor is further configured to release the SRS configuration when the transceiver fails to receive an SRS on a configured number of consecutive occasions for SRS transmission when the UE is in the RRC idle state.

Some embodiments of the present disclosure provide a method performed by a UE. The method includes: receiving an SRS configuration for an RRC idle state via an RRC connection release message; transitioning from an RRC connected state to the RRC idle state; and performing UL positioning in the RRC idle state in accordance with the SRS configuration.

Some embodiments of the present disclosure provide a method performed by a BS. The method includes: determining to transition a UE from an RRC connected state to an RRC idle state; transmitting an SRS configuration for the RRC idle state via an RRC connection release message; and performing SRS reception for UL positioning in accordance with the SRS configuration after the UE is transitioned to the RRC idle state.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method performed by a UE according to some embodiments of the present disclosure.

FIG. 3 illustrates a flowchart of an exemplary method performed by a BS according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

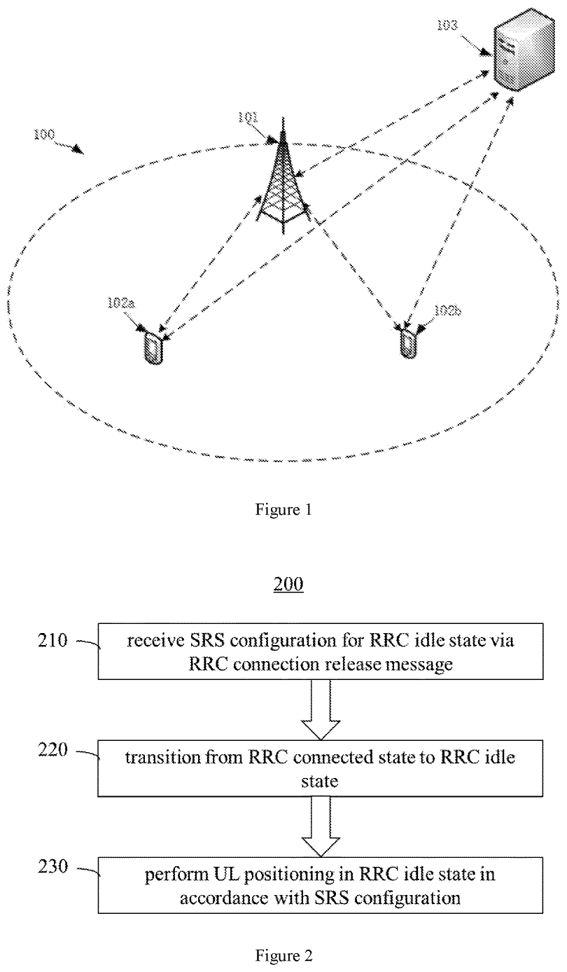

FIG. 1 is a schematic diagram illustrating an exemplary wireless communication system 100 according to some embodiments of the present disclosure.

As shown in FIG. 1, the wireless communication system 100 includes at least one BS 101, at least one UE (e.g., a UE 102a and a UE 102b), and at least one LMF 103. Although one BS, two UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) RAN node, a node-B, an enhanced node B (eNB), a gNB, a home node-B, a relay node, or a device, or described using other terminology used in the art. The BS 101 is generally part of a RAN that may include a controller communicably coupled to the BS 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the example of FIG. 1 are in a coverage area of the BS 101, and may communicate with the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a or UE 102b via LTE positioning protocol (LPP) signaling. In the present disclosure, both LMF and BS may be referred to as a network entity or the network.

For a UE (e.g., UE 102a or UE 102b) in an RRC connected state, a connection is established between the UE and a BS (e.g., BS 101), and a connection is also established between the UE and an LMF (e.g., LMF 103). The UE in the RRC connected state may receive an SRS configuration from the BS, and transmit SRS for UL positioning according to the SRS configuration.

When a UE (e.g., UE 102a or UE 102b) transitions from the RRC connected state to an RRC inactive state, the connection between the UE and a BS (e.g., BS 101) is released, e.g., upon an RRC connection release message (e.g., RRCConnectionRelease in LTE or RRCRelease in NR) from the BS, while a connection between the UE and an LMF (e.g., LMF 103) is maintained. In the case that the RRC connection release message includes an SRS configuration for the RRC inactive state and a suspend indicator (e.g., Suspendconfig) for the SRS configuration is set, the UE may keep using the SRS configuration while it is in the RRC inactive state unless validity criteria fail, e.g., upon cell reselection, TA invalidation, etc.

When a UE (e.g., UE 102a or UE 102b) transitions from the RRC connected state to an RRC idle state, both the connection between the UE and a BS (e.g., BS 101) and the connection between the UE and an LMF (e.g., LMF 103) are released, e.g., upon an RRC connection release message (e.g., RRCConnectionRelease in LTE or RRCRelease in NR) from the BS, and an LPP and UE context in the network may be released, which may cause various issues on e.g., SRS configuration, TA maintenance, etc. if the UE needs to perform UL positioning in the RRC idle state. Accordingly, a new SRS configuration mechanism may need to be defined for UEs in the RRC idle state to perform UL positioning. Moreover, TA validation and TA command transmission may need to be enhanced for UEs in the RRC idle state to implement TA.

Moreover, a UE (e.g., UE 102a or UE 102b) may release any cell-specific configuration when the UE performs a cell reselection to a cell different from the cell where the cell-specific configuration is configured. This also needs to be considered in designing the SRS configuration mechanism for UEs in the RRC idle state, e.g., to avoid acquiring a new SRS configuration frequently across cell for a power saving purpose.

The present disclosure at least provides various solutions for implementing UL positioning when a UE is in the RRC idle state, including but not limited to the details for SRS configuration, TA maintenance and validation, etc.

FIG. 2 illustrates an exemplary method 200 performed by a UE (e.g., UE 102a or UE 102b) according to some embodiments of the present disclosure. The UE may support UL positioning in the RRC idle state. It is contemplated that the method 200 may also be performed by other devices with similar functions. The embodiments of FIG. 2 described below may involve some operations performed at the network side (e.g., by a BS), which are only for purpose of illustration and not intended to limit the operations performed by the UE.

In step 210, the UE may receive, from a BS (e.g., the BS 101), an SRS configuration (e.g., SRS_IDLEConfig) for the RRC idle state via an RRC connection release message (e.g., RRCRelease).

In some embodiments, the UE may transmit a request (e.g., idlePosSRS_ConfiguartionRequest) for the SRS configuration for the RRC idle state to the BS when the UE is in the RRC connected state. In some embodiments, this may apply in a mobile originated location request (MO-LR) scenario, in which the UE may send a request to a serving public land mobile network (PLMN) for location related information for the UE. For example, the UE may transmit a request indicating to the BS that it is interested in being configured with an SRS configuration for the RRC idle state, e.g., via an idlePosSRS_ConfiguartionRequest message. After reception of the request, the BS may determine to transition the UE from the RRC connected state to the RRC idle state or the RRC inactive state, e.g., according to subscription information, local policies, UE capability information, etc. If the BS determines to transition the UE from the RRC connected state to the RRC inactive state, the BS may transmit an SRS configuration for the RRC inactive state to the UE via the RRC connection release message. If the BS determines to transition the UE from the RRC connected state to the RRC idle state, the BS may transmit the SRS configuration for the RRC idle state to the UE via the RRC connection release message.

In some embodiments, the request for the SRS configuration for the RRC idle state may include at least positioning capability information indicating that the UE supports UL positioning in the RRC idle state.

Additionally or alternatively, the request for the SRS configuration for the RRC idle state may include at least a low power requirement of a positioning service, e.g., low power high accuracy positioning (LPHAP).

In some embodiments, the UE may receive the SRS configuration for the RRC idle state without transmitting a request to the BS. In some embodiments, this may apply in a mobile terminated location request (MT-LR) scenario or a deferred MT-LR scenario. In an MT-LR scenario, a location service (LCS) client or application function (AF) external to or internal to a serving PLMN (e.g., home PLMN (HPLMN) or visited PLMN (VPLMN)) may send a location request to the serving PLMN for the location of the UE. In a deferred MT-LR scenario, the LCS client or AF may send a location request to the serving PLMN for the location of the UE and expect to receive a response containing the indication of event occurrence and location information if requested for the UE at some future time(s), which may be associated with specific events associated with the UE. The events may include UE availability, area, period timer expiration or motion, etc.:
UE availability: any event in which the 5G CN has established a contact with the UE.
Area: an event where the UE enters, leaves or remains within a pre-defined geo area.
Periodic timer expiration: an event where a defined periodic timer expires in the UE and the UE activates a location report.
Motion: an event where the UE moves by more than some pre-defined straight-line distances from a previous location.

In some embodiments, when there is no other ongoing data transmission except for positioning service (e.g., UL SRS transmission), the BS may determine to transition the UE from the RRC connected state to the RRC idle state. If the BS was notified that the UE supports UL positioning in the RRC idle state, it may provide an SRS configuration for the RRC idle state in an RRC connection release message transmitted to the UE.

In some embodiments, the BS may configure a positioning area associated with the SRS configuration for the RRC idle state. The positioning area may also be provided to the UE via the RRC connection release message. The positioning area may include cells within which the BS may perform SRS reception and measurement for the UE while the UE is in the RRC idle state. In some embodiments, the positioning area may include at least one of: one or more cells within a CN tracking area or RNA; one or more cells managed by a same LMF as a serving cell where the SRS configuration is received; one or more neighboring cells surrounding the serving cell; or one or more cells within a range of the serving cell (e.g., within a range defined by a specific distance from the serving cell).

In the case that the positioning area associated with the SRS configuration is configured, the SRS configuration is valid only when the UE is within the serving cell where the SRS configuration is received or within the positioning area.

In the case that the positioning area associated with the SRS configuration is not configured, the SRS configuration is valid only when the UE is within the serving cell where the SRS configuration is received.

As shown in FIG. 2, after receiving the RRC connection release message, the UE may transition from the RRC connected state to the RRC idle state in step 220. For example, when the UE receives the RRC connection release message, it may release all radio resources, e.g., medium access control (MAC) configuration, radio link control (RLC) entity and the associated packet data convergence protocol (PDCP) entity and service data adaptation protocol (SDAP) entity (if any) for all established resource blocks (RBs). In the case that the RRC connection release message includes the SRS configuration for the RRC idle state, the UE may store the SRS configuration for the RRC idle state and apply the SRS configuration when the UE enters into the RRC_IDLE state.

In some embodiments, the RRC connection release message received in step 210 may further include a valid time associated with the SRS configuration for the RRC idle state. When the valid time expires, both the BS (or the network) and the UE may release the SRS configuration for the RRC idle state.

In some embodiments, the SRS configuration may include a TA configuration, SRS transmission related parameter(s), etc. The TA configuration may include a TA timer (e.g., idlePosSRS-TimeAlignmentTimer) and an RSRP change threshold (e.g., idlePosSRS-RSRPChange Threshold). Upon reception of the TA configuration, the UE may start the TA timer and store an RSRP value of the serving cell where the TA configuration is received as a current serving cell RSRP value. The TA timer may be used to indicate whether the Layer 1 between the UE and the BS can be synchronized: if the TA timer expires, it indicates that the Layer 1 between the UE and the BS is out of synchronization. If the difference between a current RSRP value measured by the UE and a current serving cell RSRP value stored on the UE exceeds the RSRP change threshold in the TA configuration, it indicates that the Layer 1 between the UE and the BS is out of synchronization.

In step 230, the UE may perform UL positioning in the RRC idle state in accordance with the stored SRS configuration for the RRC idle state. For example, the UE may transmit an SRS on each configured SRS occasion unless validity criteria fail, and the BS may perform SRS reception and measurement accordingly.

In some embodiments, the UE needs to check TA validation and SRS configuration validation before each SRS transmission for UL positioning when the UE is in the RRC idle state. In some embodiments, the UE performs the SRS transmission only when both the SRS configuration and a current TA are determined to be valid.

In some embodiments, the UE may determine that the SRS configuration for the RRC idle state is valid when the SRS transmission related parameters in the stored SRS configuration (e.g., resource block, bandwidth, etc.) for the serving cell where the UE is currently located are decoded successfully. In some other embodiments, the UE may determine that the SRS configuration for the RRC idle state is invalid when the stored SRS configuration is not for the serving cell or the UE fails to decode the SRS transmission related parameters in the stored SRS configuration (e.g., resource block, bandwidth, etc.) for the serving cell.

The current TA may be associated with a current TA configuration, which may include a current TA timer and a current RSRP change threshold, and the current TA may be specific to a cell where the current TA configuration is received. In some embodiments, the UE may determine that the current TA is valid when the following conditions are satisfied:
the current TA timer associated with the current TA is running; and
an RSRP change does not exceed the current RSRP change threshold associated with the current TA.

Herein, the RSRP change refers to a difference between a current RSRP value measured by the UE and a current serving cell RSRP value stored on the UE, where the current serving cell RSRP value may be an RSRP value of the cell associated with the current TA when the UE receives the current TA configuration.

In some embodiments, the UE may determine that the current TA is invalid in at least one of the following cases:
the current TA timer associated with the current TA expires;
the UE moves to a cell different from that associated with the current TA; or
an RSRP change exceeds the current RSRP change threshold associated with the current TA

An initial TA may be associated with the TA configuration included in the SRS configuration received in step 210. The TA or the TA configuration may be updated upon reception of a TA command or TA update. In some embodiments, the TA command or TA update may be signaled by the BS to the UE in the RRC idle state via a DCI signaling with CRC scrambled by an RNTI associated with the UE. In an embodiment, the RNTI may be configured to the UE via the RRC connection release message, and the UE may store the RNTI for use in the RRC idle state after receiving the RRC connection release message.

In some embodiments, the DCI signaling may be transmitted from the BS to the UE following a configured SRS transmission period or interval according to the SRS configuration. In some embodiments, the UE may restart the TA timer upon reception of the DCI signaling.

In some embodiments, when the current TA is determined to be invalid, the UE may determine that the SRS configuration for the RRC idle state is invalid.

In some embodiments, when the SRS configuration for the RRC idle state becomes invalid, the UE may release the SRS configuration.

In some other embodiments, the UE may suspend the SRS configuration for the RRC idle state when the current TA is determined to be invalid, and may resume the SRS configuration when the current TA becomes valid or a new TA (or a new TA configuration) is acquired successfully. In the case that a new TA is acquired, resuming the SRS configuration may mean continuing to use other configuration information or parameters included in the SRS configuration but updating the TA configuration.

In some embodiments, in the case that a positioning area associated with the SRS configuration is configured, and the UE moves from a first cell within the positioning area to a second cell within the positioning area, the UE may keep using other configuration information or parameters included in the SRS configuration but acquire a new TA configuration associated with the second cell (i.e., acquire time alignment with the second cell), e.g., via a random access (RA) procedure. In some embodiments, the RA procedure may be a 4-step RA procedure, in which: the UE may transmit an MSG1 by using a preamble and PRACH resource configured in an SIB; the BS may transmit an MSG2 including the new TA configuration (including a new TA timer, a new RSRP change threshold, etc.) upon reception of the MSG1; and then the UE may apply the new TA configuration and start the new TA timer after acquiring the new TA configuration, and not transmit an MSG3 after reception of the MSG2. In some embodiments, the RA procedure may be a 2-step RA procedure, in which: the UE may transmit an MSGA by using a preamble and PRACH resource configured in an SIB; the BS may transmit an MSGB including the new TA configuration (including a new TA timer, a new RSRP change threshold, etc.) upon reception of the MSGA; and then the UE may apply the new TA configuration and start the new TA timer after acquiring the new TA configuration. Applying the new TA configuration may include storing the new TA configuration and storing a current RSRP value of the second cell as the current serving cell RSRP value. In some embodiments, the preamble or PRACH resource used in the aforementioned RA procedure may be a dedicated preamble or PRACH resource for SRS TA purpose or a shared preamble or PRACH resource.

In some embodiments, in the case that a positioning area associated with the SRS configuration is configured, when the UE moves out of the positioning area, the UE may release the SRS configuration for the RRC idle state, and determine that the current TA is invalid.

In some embodiments, when the UE performs a cell reselection or initiates an RRC resume procedure to a cell different from a serving cell where the UE receives the RRC connection release message, the UE may release the SRS configuration for the RRC idle state.

In some embodiments, when the SRS configuration for the RRC idle state has not been used for a configured number of consecutive occasions for SRS transmission in the RRC idle state, both the BS (or the network) and the UE may release the SRS configuration. Occasions for SRS transmission may also be referred to as SRS occasions.

For example, in the case that a one-shot SRS transmission is configured for UL positioning in the RRC idle state (e.g., SRS_IDLE Num_occasion is set to one), if the SRS configuration is not used for the configured occasion, e.g., the UE does not initiate an SRS transmission on the configured occasion (i.e., the BS does not receive an SRS on the configured occasion) when the conditions for SRS transmission are fulfilled (e.g., the SRS configuration is valid and the current TA is valid), then both the BS (or the network) and the UE may release the SRS configuration. It is contemplated that, for the one-shot SRS transmission, both the BS (or the network) and the UE will also release the SRS configuration after the completion of the SRS transmission. In some embodiments, when the UE releases the SRS configuration, the UE may release the TA timer, for example, the UE may indicate to lower layers that the TA timer is released.

For example, in the case that periodic SRS transmissions are configured for UL positioning in the RRC idle state (e.g., SRS_IDLE Num_occasion is set to N, which is an positive integer>1), the subsequent SRS occasions occur periodically after the occurrence of a first SRS occasion. For each SRS occasion occurring when the UE is in the RRC idle state, if the SRS configuration is not used for the SRS occasion, e.g., the UE does not initiate an SRS transmission on the SRS occasion when the conditions for SRS transmission are fulfilled (e.g., the SRS configuration is valid and the current TA is valid), or the UE receives an SRS transmission failure indication from lower layers, the UE may consider the SRS occasion as being skipped (in such cases, the BS does not receive an SRS on the SRS occasion). When the number of consecutive SRS occasions skipped in the RRC idle state reaches a configured number, both the BS (or the network) and the UE may release the SRS configuration. In some embodiments, when the UE releases the SRS transmission, the UE may release the TA timer, for example, the UE may indicate to lower layers that the TA timer is released.

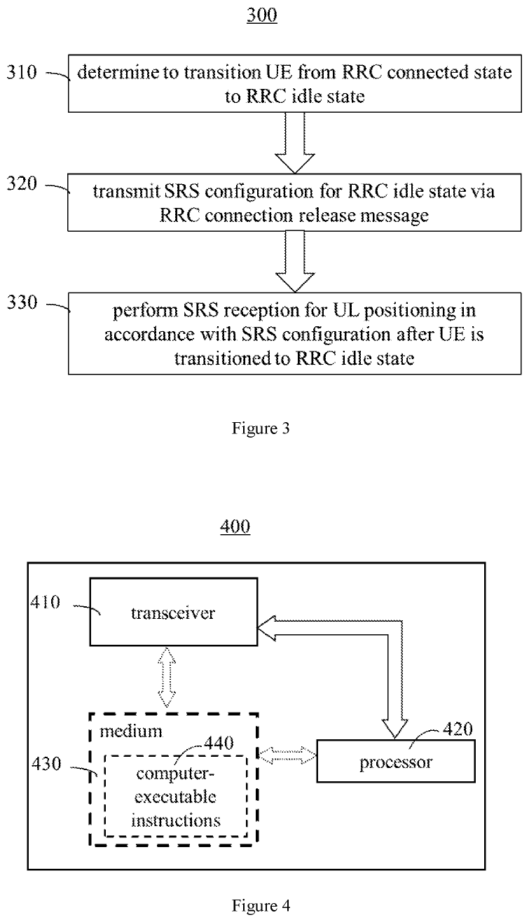

FIG. 3 illustrates an exemplary method 300 performed by a BS (e.g., BS 101) or other devices with similar functions according to some embodiments of the present disclosure. At least some of the operations performed by the BS may be the same as those described in the above embodiments of FIG. 2.

In step 310, the BS may determine to transition a UE from the RRC connected state to the RRC idle state. For example, when there is no other ongoing data transmission except for positioning service, the BS may determine to transition the UE from the RRC connected state to the RRC idle state. The BS may be previously informed that the UE supports UL positioning in the RRC idle state.

In some other examples, the BS may determine to transition the UE from the RRC connected state to the RRC idle state after receiving a request (e.g., idlePosSRS_ConfiguartionRequest) for an SRS configuration for the RRC idle state from the UE when the UE is in the RRC connected state. In some embodiments, the request may include at least one of: positioning capability information indicating that the UE supports UL positioning in the RRC idle state; or a low power requirement of a positioning service, e.g., LPHAP.

In step 320, the BS may transmit an SRS configuration (e.g., SRS_IDLEConfig) for the RRC idle state via an RRC connection release message (e.g., RRCRelease).

In some embodiments, the RRC connection release message may include a positioning area associated with the SRS configuration. The positioning area may include cells within which the BS may perform SRS reception and measurement for the UE while the UE is in the RRC idle state. In some embodiments, the positioning area may include at least one of: one or more cells within a CN tracking area or RNA; one or more cells managed by a same LMF as a serving cell where the SRS configuration is transmitted; one or more neighboring cells surrounding the serving cell; or one or more cells within a range of the serving cell (e.g., within a range defined by a specific distance from the serving cell).

In the case that the positioning area associated with the SRS configuration is configured, the SRS configuration is valid only when the UE is within the serving cell where the SRS configuration is transmitted or within the positioning area.

In the case that the positioning area associated with the SRS configuration is not configured, the SRS configuration is valid only when the UE is within the serving cell where the SRS configuration is transmitted.

In some embodiments, the RRC connection release message may further include a valid time associated with the SRS configuration for the RRC idle state. Both the BS (or the network) and the UE may release the SRS configuration for the RRC idle state when the valid time expires.

In some embodiments, the SRS configuration may include a TA configuration, SRS transmission related parameter(s), etc. The TA configuration may include a TA timer (e.g., idlePosSRS-TimeAlignmentTimer) and an RSRP change threshold (e.g., idlePosSRS-RSRPChangeThreshold). In some embodiments, the BS may transmit DCI signaling with CRC scrambled by an RNTI associated with the UE when the UE is in the RRC idle state. The RNTI is used for identifying DCI signaling for the UE in the RRC idle state. In some embodiments, the BS may transmit the RNTI to the UE via the RRC connection release message. The DCI signaling may include a TA command or TA update. Upon reception of the DCI signaling, the UE may restart the TA timer. In some embodiments, the BS may transmit the DCI signaling following a configured SRS transmission period or interval according to the SRS configuration.

In some embodiments, in the case that the RRC connection release message includes a positioning area associated with the SRS configuration, the BS may receive, from the UE in the RRC idle state, an MSG1 or MSGA with a preamble and PRACH resource configured in an SIB, e.g., when the UE in the RRC idle state moves from a first cell within the positioning area to a second cell within the positioning area. Then, the BS may transmit an MSG2 or MSGB including a new TA configuration to the UE. In some embodiments, the preamble or PRACH resource may be a dedicated preamble or PRACH resource for SRS TA purpose or a shared preamble or PRACH resource.

As shown in FIG. 3, in step 330, the BS may perform SRS reception for UL positioning in accordance with the SRS configuration after the UE is transitioned to the RRC idle state. In some embodiments, in the case that a positioning area associated with the SRS configuration is configured, cell(s) within the positioning area (which may include cell(s) of the BS or other BS(s)) may perform SRS reception and measurement associated with the UE. In other words, the BS (or other BS(s)) may perform SRS reception and measurement associated with the UE in cell(s) within the positioning area.

In some embodiments, when the BS fails to receive an SRS on a configured number of consecutive occasions for SRS transmission when the UE is in the RRC idle state, the BS may release the SRS configuration. As a particular example, in the case that a one-shot SRS transmission is configured for UL positioning in the RRC idle state (e.g., SRS_IDLE Num_occasion is set to one), the BS may release the SRS configuration when the BS fails to receive an SRS on the configured occasion.

FIG. 4 illustrates a simplified block diagram of an exemplary apparatus 400 according to some embodiments of the present disclosure.

In some embodiments, the apparatus 400 may be or include at least part of a UE which is capable of performing the aforementioned methods (e.g., method 200) for UL positioning in the RRC idle state.

In some embodiments, the apparatus 400 may be or include at least part of a BS which is capable of performing the aforementioned methods (e.g., method 300) for UL positioning from the network side.

As shown in FIG. 4, the apparatus 400 may include at least a transceiver 410 and a processor 420 coupled to transceiver 410. In some embodiments, the transceiver 410 may include a transmitter and a receiver integrated together. In some embodiments, the transceiver 410 may include a transmitter and a receiver which are separated from each other. In some embodiments, the transceiver 410 may be a wireless transceiver.

In some embodiments, the apparatus 400 may include a non-transitory computer-readable medium 430 with computer-executable instructions 440 stored thereon. The non-transitory computer-readable medium 430 may be coupled to the processor 420 and the transceiver 410, and the computer-executable instructions 440 may be configured to be executable by the processor 420. In some embodiments, the transceiver 410, the non-transitory computer-readable medium 430, and the processor 420 may be coupled to each other via one or more local buses.

Although in FIG. 4, elements such as the transceiver 410, the non-transitory computer-readable medium 430, and the processor 420 are described in the singular, the plural is contemplated unless limitation to the singular is explicitly stated. In certain embodiments of the present disclosure, the apparatus 400 may further include other components for actual usage.

In various example embodiments, the processor 420 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 420 may also include at least one other circuitry or element not shown in FIG. 4.

In various example embodiments, the non-transitory computer-readable medium 430 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 430 may include, but is not limited to, an electric, a magnetic, an optical, an electromagnetic, an infrared, or a semiconductor system, apparatus, or device or any combination of the above.

Further, in various example embodiments, the apparatus 400 may also include at least one other circuitry, element, and interface, for example antenna element, and the like.

According to some embodiments, the apparatus 400 is a UE. The transceiver 410 and the processor 420 may be configured to perform operations in any methods described above which are performed by a UE. For example, the transceiver 410 may be configured to receive an SRS configuration for the RRC idle state via an RRC connection release message, and the processor 420 may be configured to transition from the RRC connected state to the RRC idle state and perform UL positioning in the RRC idle state in accordance with the SRS configuration.

According to some embodiments, the apparatus 400 is a BS. The transceiver 410 and the processor 420 may be configured to perform operations in any methods described above which are performed by a BS. For example, the processor 420 may be configured to determine to transition a UE from an RRC connected state to an RRC idle state, and the transceiver 410 may be configured to transmit an SRS configuration for the RRC idle state via an RRC connection release message and perform SRS reception for UL positioning in accordance with the SRS configuration after the UE is transitioned to the RRC idle state.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE), comprising:
at least one memory; and
at least one processor coupled with the at least one memory and configured to cause the UE to:
receive a sounding reference signal (SRS) configuration for a radio resource control (RRC) idle state via an RRC connection release message;
transition from an RRC connected state to the RRC idle state; and
perform uplink (UL) positioning in the RRC idle state in accordance with the SRS configuration.

2. The UE of claim 1, wherein the at least one processor is configured to cause the UE to transmit a request for the SRS configuration for the RRC idle state when the UE is in the RRC connected state, and wherein the request includes at least one of:
positioning capability information indicating that the UE supports UL positioning in the RRC idle state; or
a low power requirement of a positioning service.

3. The UE of claim 1, wherein the RRC connection release message further includes a positioning area associated with the SRS configuration.

4. The UE of claim 3, wherein the positioning area includes at least one of:
one or more cells within a core network (CN) tracking area or radio access network (RAN) based notification area (RNA);
one or more cells managed by a same location management function (LMF) as a serving cell where the SRS configuration is received;
one or more neighboring cells surrounding the serving cell; or
one or more cells within a range of the serving cell.

5. The UE of claim 3, wherein the SRS configuration is valid only when the UE is within a serving cell where the SRS configuration is received or within the positioning area.

6. The UE of claim 1, wherein the SRS configuration includes a first time alignment (TA) configuration, wherein the first TA configuration includes a TA timer and a reference signal received power (RSRP) change threshold, and wherein the at least one processor is configured to cause the UE to start the TA timer and store an RSRP value of a serving cell where the first TA configuration is received as a current serving cell RSRP value upon reception of the first TA configuration.

7. The UE of claim 6, wherein the RRC connection release message further includes a radio network temporary identity (RNTI) for identifying downlink control information (DCI) signaling for the UE in the RRC idle state.

8. The UE of claim 7, wherein the at least one processor is configured to cause the UE to:
receive DCI signaling with cyclic redundancy check (CRC) scrambled by the RNTI when the UE is in the RRC idle state, wherein the DCI signaling includes a TA command or a TA update; and
restart the TA timer upon reception of the DCI signaling.

9. The UE of claim 6, wherein, if a positioning area associated with the SRS configuration is configured and the UE moves from a first cell within the positioning area to a second cell within the positioning area, the at least one processor is configured to cause the UE to acquire a second TA configuration associated with the second cell.

10. The UE of claim 9, wherein to acquire the second TA configuration, the at least one processor is configured to cause the UE to:
transmit an MSG1 or MSGA by using a preamble and physical random access channel (PRACH) resource configured in a system information block (SIB); and
receive an MSG2 or MSGB including the second TA configuration, without transmitting an MSG3; and
apply the second TA configuration and start a TA timer according to the second TA configuration after acquiring the second TA configuration.

11. The UE of claim 6, wherein the at least one processor is configured to cause the UE to perform the following operations before each SRS transmission when the UE is in the RRC idle state:
determining whether the SRS configuration is valid; and
determining whether a current TA is valid; and
wherein the SRS transmission is performed if both the SRS configuration and the current TA are determined to be valid.

12. The UE of claim 11, wherein the at least one processor is configured to cause the UE to determine that the SRS configuration is invalid when the current TA is invalid.

13. The UE of claim 1, wherein the at least one processor is configured to cause the UE to:
release the SRS configuration when the SRS configuration has not been used for a configured number of consecutive occasions for SRS transmission in the RRC idle state; and/or
release the SRS configuration when a cell reselection is performed or an RRC resume procedure is initiated to a cell different from a serving cell where the RRC connection release message is received.

14. A base station, comprising:
at least one memory; and
at least one processor coupled with the at least one memory and configured to cause the base station to:
determine to transition a user equipment (UE) from a radio resource control (RRC) connected state to an RRC idle state;
transmit a sounding reference signal (SRS) configuration for the RRC idle state via an RRC connection release message; and
perform SRS reception for uplink (UL) positioning in accordance with the SRS configuration after the UE is transitioned to the RRC idle state.

15. A method performed by a user equipment (UE), the method comprising:
receiving a sounding reference signal (SRS) configuration for a radio resource control (RRC) idle state via an RRC connection release message;
transitioning from an RRC connected state to the RRC idle state; and
performing uplink (UL) positioning in the RRC idle state in accordance with the SRS configuration.

16. A processor for wireless communication, comprising:
at least one controller coupled with at least one memory and configured to cause the processor to:
receive a sounding reference signal (SRS) configuration for a radio resource control (RRC) idle state via an RRC connection release message;
transition from an RRC connected state to the RRC idle state; and
perform uplink (UL) positioning in the RRC idle state in accordance with the SRS configuration.

17. The processor of claim 16, wherein the at least one controller is configured to cause the processor to transmit a request for the SRS configuration for the RRC idle state when the processor is in the RRC connected state, and wherein the request includes at least one of:
positioning capability information indicating that the processor supports UL positioning in the RRC idle state; or
a low power requirement of a positioning service.

18. The processor of claim 16, wherein the RRC connection release message further includes a positioning area associated with the SRS configuration.

19. The processor of claim 18, wherein the positioning area includes at least one of:
one or more cells within a core network (CN) tracking area or radio access network (RAN) based notification area (RNA);
one or more cells managed by a same location management function (LMF) as a serving cell where the SRS configuration is received;
one or more neighboring cells surrounding the serving cell; or
one or more cells within a range of the serving cell.

20. The processor of claim 18, wherein the SRS configuration is valid only when the processor is within a serving cell where the SRS configuration is received or within the positioning area.
